(19) United States
(12) Patent Application Publication
(10) Pub. No.: US 2026/0296099 A1
(43) Pub. Date: Oct. 1, 2026

(54) DEFLECTOR FOR RIMS, FOR EXAMPLE CAR RIMS

(71) Applicant: SOFTCAR SA, FRIBOURG (CH)

(72) Inventors: Etienne CROZIER, La Neuveville (CH); Guillaume HEISEL, Bienne (CH); Jean-Luc THULIEZ, Le Landeron (CH); Quentin ALEXANDRE, La Neuveville (CH); Nicolas OBLIGER, Châtillon-le-Duc (FR)

(21) Appl. No.: 19/480,172

(22) PCT Filed: May 3, 2024
(86) PCT No.: PCT/IB2024/054339

§ 371 Date: Oct. 30, 2025

(30) Foreign Application Priority Data
May 4, 2023 (WO) PCT/IB2023/054660

(51) Int. Cl. B60B 7/04; B60B 7/00; B60B 7/06; B60B 7/08

(52) U.S. Cl. CPC B60B 7/04; B60B 7/0013; B60B 7/004; B60B 7/0053; B60B 7/006; B60B 7/0066; B60B 7/063; B60B 7/068; B60B 7/08; B60B 2360/32; B60B 2360/36; B60B 2900/1216; B60B 2900/212; B60B 2900/572

(57) ABSTRACT

The invention relates to an insert (10) on a rim (1), for example a car rim, said insert simultaneously carrying out the functions of an aerodynamic deflector, of protecting the rim, for example during an impact against a curb, and of a stylized customization element.

### CORRESPONDING APPLICATION

The present application claims the priority of the earlier application PCT/IB2023/054660 filed on May 4, 2023 in the name of SOFTCAR SA, the content of that earlier application being incorporated by reference in its entirety into the present application.

### FIELD OF THE INVENTION

The invention relates to the field of rims for vehicles, in particular rims for automobiles, and to means used to improve the performance of said vehicles.

### PRIOR ART

Since the beginnings of the automobile, rims have formed an integral part of the style of the vehicle. On electric cars, to reduce aerodynamic drag, aerodynamic deflectors have appeared that completely cover the rims (for example made of aluminum), allowing air to be extracted from the inside of the wheel arches to the outside of the vehicle. The function of these deflectors is to reduce aerodynamic drag and therefore to increase the range of the vehicle concerned. These deflectors are generally made of injection-molded synthetic materials (such as polymers) and have the shape of a cover disk completely covering the structural rim which is made of steel or aluminum.

Some high-end rims comprise vanes like a turbine directly integrated into the aluminum casting. Located toward the center of the rim they are ineffective in extracting air, and the right and left rims are mirrored because of the orientation of the vanes: it is therefore necessary to produce different rims for the left-hand and right-hand side and in addition, during mounting, care must also be taken to mount them on the correct side. It is therefore not possible to cross these rims (for example to take account of the wear of the tires) without also having to change the mounted tire.

In addition, the rims may sometimes be equipped with continuous strapping on the rim edge to protect them from impacts, for example against sidewalks or curbs.

### Problem

In the prior art, the structural rim, for example made of cast aluminum alloy, is covered with a plastic wheel trim or “Aero Wheel”. The deflector cap resembles painted plastic wheel trims or hubcaps installed 40 years ago to conceal the “low-end” steel rims and thus simulate the look of aluminum rims. This deflector solution, which is found on a number of electric vehicles, is not esthetically beneficial and many users remove this polymer part to show the rim, for example made of aluminum, situated behind, which cancels out the aerodynamic gain and the energy saving achieved by this part. The polymer wheel trim is ineffective, fragile and always of the same shade. The wheel trim adds a high unsuspended mass to an electric vehicle, which is contradictory to the greatest possible lightness in order to consume the minimum of energy. It is clipped onto the rim in a non-permanent manner to allow access for demounting a wheel. This non-permanent clipping poses a problem because a wheel trim that is not properly remounted, or following an impact, can detach from the rim, and leads to pollution on the edges of the roads that is particularly visible because of its size. Similarly, fragments of the wheel trim detach. This unpleasant pollution is a sign of irresponsible consumption that is unacceptable for an environmentally friendly vehicle. During demounting or remounting, the wheel trims are dirty, complicated to remount and lead to breakage of the clipping systems.

Clipping is always complicated around the tire valve, which requires particular attention to position the wheel trim and incorrect remounting will lead to the loss of the wheel trim.

The right and left wheel trims are different so that the vanes operate in air extraction on both sides of the vehicle.

In the context of high-end rims molded with vanes like a vane turbine, as indicated above, it is necessary to produce two types of rims (left and right) to obtain a dynamic effect and this increases the costs of tooling and production, while making the mounting operation more complex, compared with the situation where all the rims are identical and can be mounted equally well on the left or on the right.

For exactly the same industrial reasons as aluminum rims, it is expensive to launch different colors into production. Thus, the colors of the rims or wheel trims are neutral, in general gray, and are thus mounted without particular harmony with the color of the vehicle body.

In addition, it is very expensive industrially to add different colors to a single rim. On a rim painted with two or more colors, the same rim paint will always be produced identically for the entire life of the vehicle, whatever the color of the body of the vehicle. For this reason, for both rims and wheel trims, manufacturers usually choose neutral, black or gray colors regardless of the range of bodywork colors.

For recycling, two-/multi-color or two-/multi-material painted rims are problematic because the colors mix or the recovered material is not pure.

The outer faces of the rims and wheel trims are painted on specific industrial paint lines. The wheel trims are painted only on the visible external face with an automotive primer. The finish of a non-professional paint on the outer face will not be aesthetic. This very strongly limits amateur decoration and personalization of the wheel trims.

High-end aluminum rims are damaged at the slightest sidewalk impact, and will need to be re-turned and then repainted to remove the traces of an impact.

Wheel trims in many cases do not protect the aluminum rim from sidewalk impacts.

### DESCRIPTION OF THE INVENTION

The aim of the present invention is to simultaneously solve these problems and makes it possible to realize several functions integrated in a single part: according to the invention, the deflector is simultaneously an aerodynamic deflector, a style element, a personalization element, and a protection of the edges of the rim against sidewalks.

These functions make it possible in particular to match the rim according to the different body colors (i.e. the bodywork) during the production of the vehicle or else to match the rim following a change in body color, or to carry out any personalization of the rim in a professional manner without touching the paint of the rim, which is for example made of aluminum.

In embodiments, the invention relates to an add-on part fitted to a rim, for example a car rim, said part simultaneously performing the functions of an aerodynamic deflector, of protecting the rim, for example from an impact against a sidewalk, and of a stylized personalization element.

In embodiments, said part forms a deflector.

In embodiments, the part comprises means for clipping on said rim in openings designed to allow said part to be clipped to the periphery of the rim.

In embodiments, the part comprises two symmetrical vanes enabling it to be mounted equally well on the right and left rims of a vehicle.

In embodiments, the part forms a central removable part mechanically and visually protecting the nuts of the rim.

In embodiments, the shape of the clips and the opening are designed so as to be non-removable from the rim branch except when a deliberate pressure on the two clips is applied simultaneously.

In embodiments, the shape of the branch of the rim allows fingers to pass on each side to press simultaneously on the two clips.

In embodiments, the clipping of the part returns an audible feedback click during its assembly, making it possible to ensure the correct locking of the part on the rim.

In embodiments, said part protects the rim from friction and sidewalk impacts.

In embodiments, said part is matched to the body tones of series or after-sales vehicles.

In embodiments, the user can vary the colors of these parts at any time at will on their vehicle.

In embodiments, the part is made of transparent polymer and makes possible, by painting the internal face, a decorative personalization using the transparency of the part.

In embodiments, the part allows the user themselves to color the internal face of these parts very easily, benefiting from an ultra-glossy finish on the face independently of the quality of application by using the transparent thickness of the part.

In embodiments, the parts are made of retro-reflecting elements reflecting light or storing and re-emitting light either by phosphorescence or by fluorescence, for example.

In embodiments, the part is made of transparent polymer and is capable of receiving varnish matching the color of the nail varnish of the user of the vehicle on the face.

In embodiments, the part can be easily unclipped and transported to accompany the user to a nail bar or to a place suitable for its decoration.

In embodiments, the part is made of transparent polymer including fillers of precious stone, flakes, glass, or any other decorative particle.

In embodiments, the part is made of transparent polymer which can be coarsely painted on its inner face, the glossy finish being ensured by the polymer thickness.

In embodiments, the part is made of a transparent or opaque through-colored material with a large choice of color and a large choice of fillers, glass, fluorescence to personalize the rims.

In embodiments, the arrangement of the clips of the part allows a passage shape in the branch corresponding to a shape for uncapping a bottle.

In embodiments, the invention relates to a rim, for example for a vehicle, comprising at least one part as defined in the present application.

In embodiments, the invention relates to a vehicle, such as, for example, a car, said vehicle comprising at least one rim as defined in the present application.

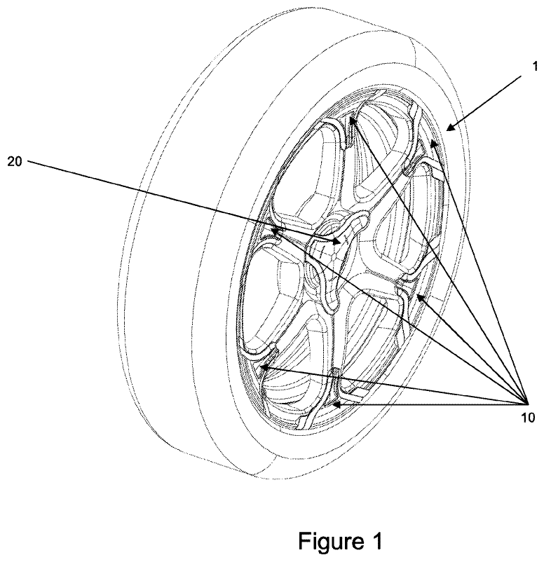

FIG. 1 illustrates the principle of the invention on a vehicle rim seen in perspective.

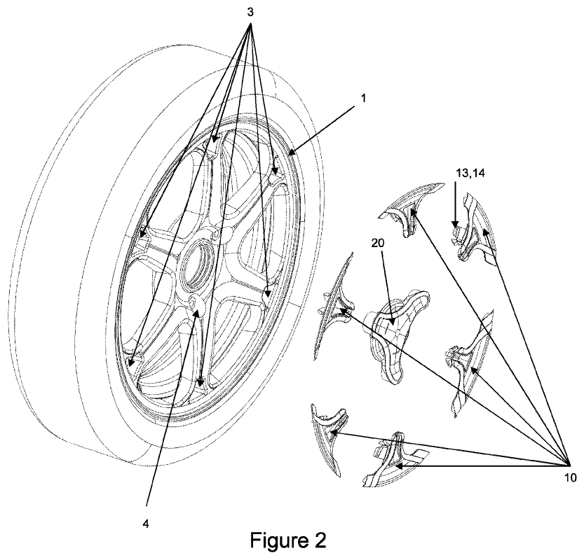

FIG. 2 illustrates an embodiment according to the invention in an exploded perspective view.

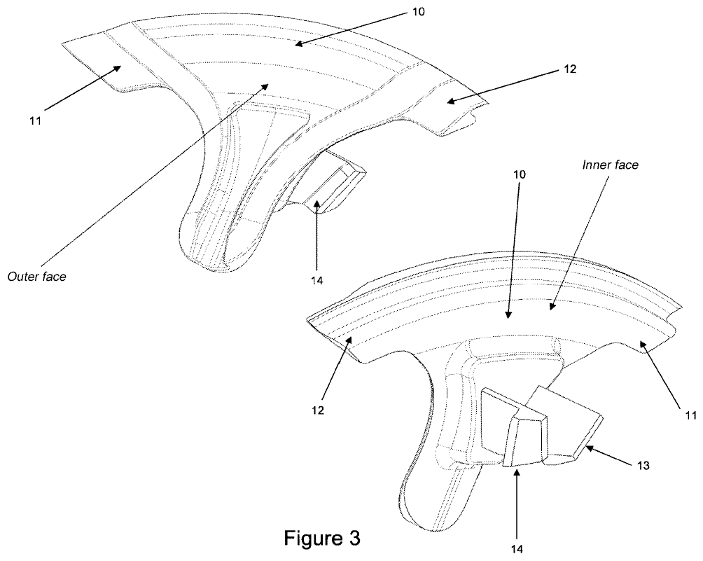

FIG. 3 illustrates an embodiment of a deflector according to the invention, seen in front and rear perspective.

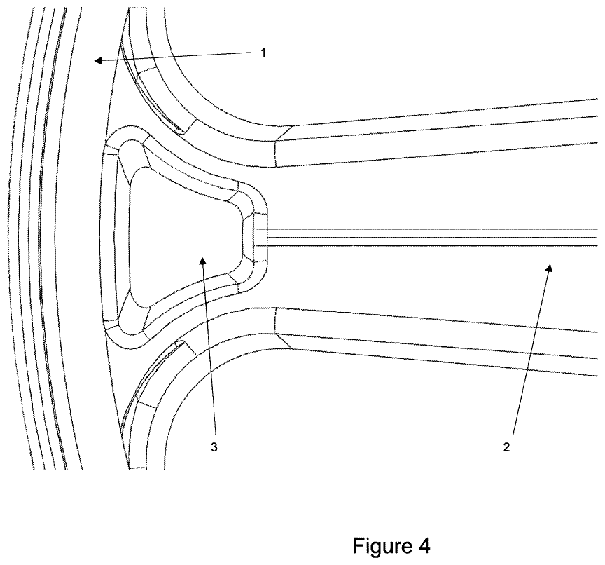

FIG. 4 illustrates a detail of a rim without a deflector.

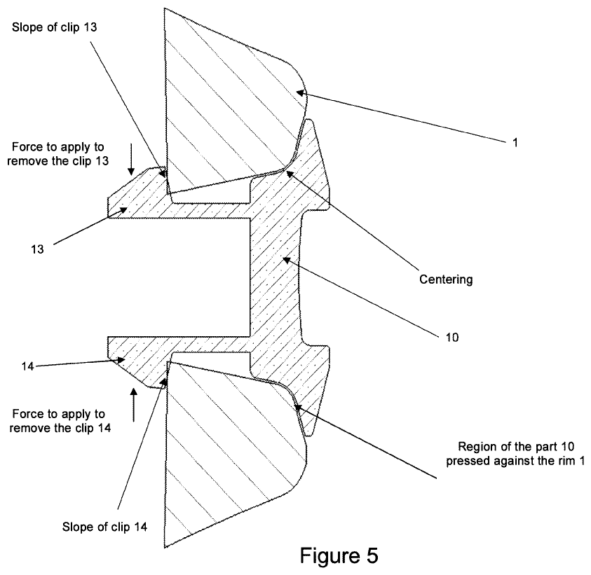

FIG. 5 illustrates a sectional view of a detail of a deflector according to the invention.

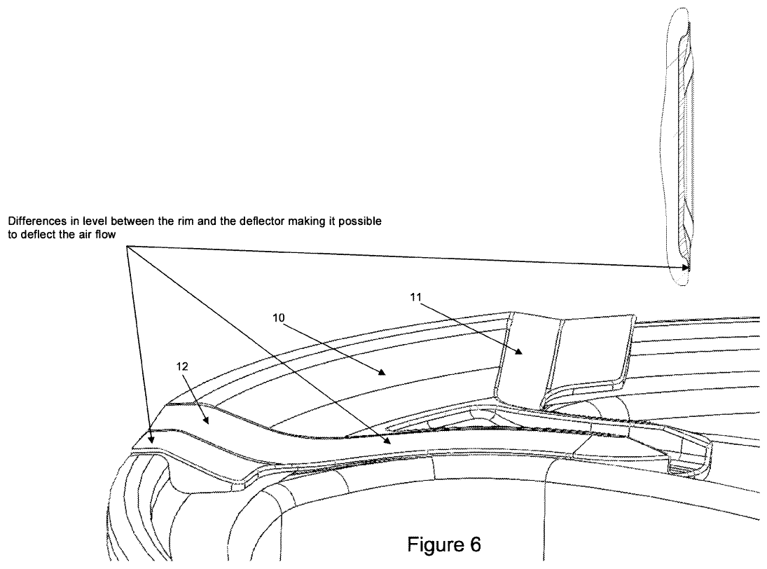

FIG. 6 illustrates the differences in level of a deflector according to the invention making it possible to deflect the air flow.

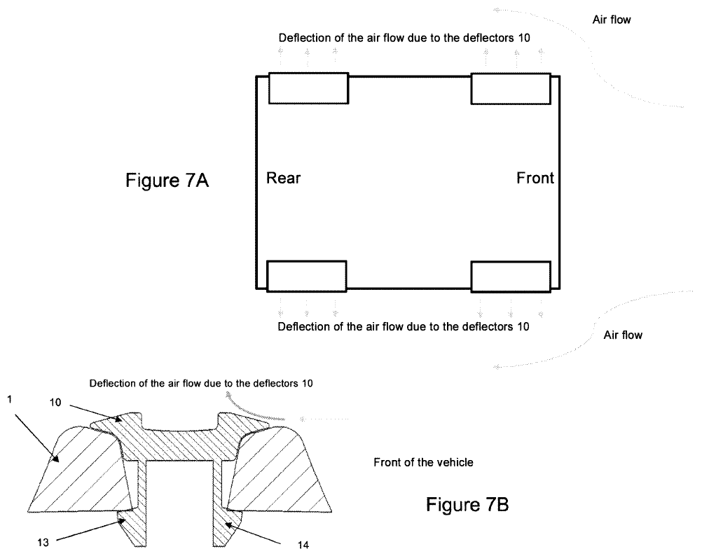

FIGS. 7A and 7B illustrate the deflections of the air flows achieved by virtue of the invention.

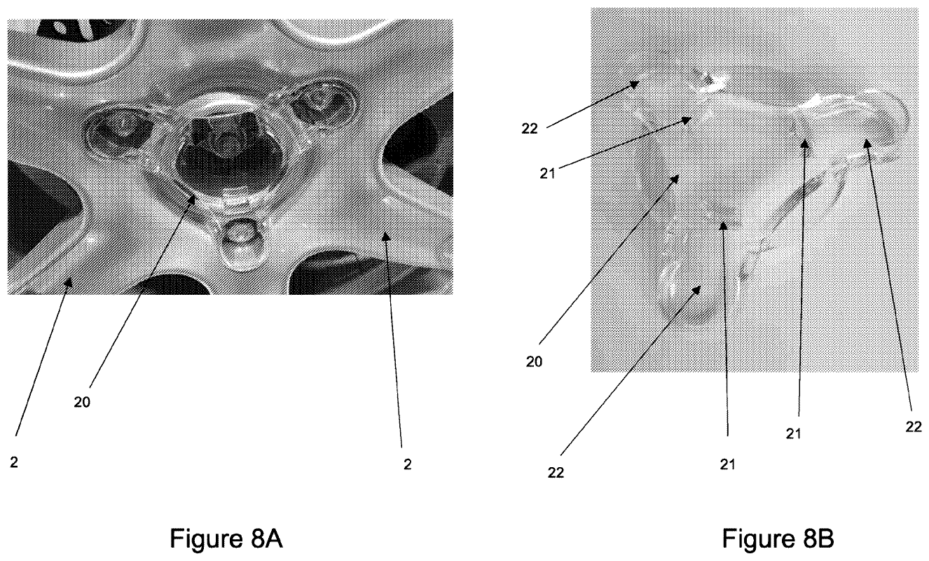

FIGS. 8A and 8B illustrate part of an embodiment of the invention, respectively in the mounted state on a rim (FIG. 8A) and in the demounted state (FIG. 8B).

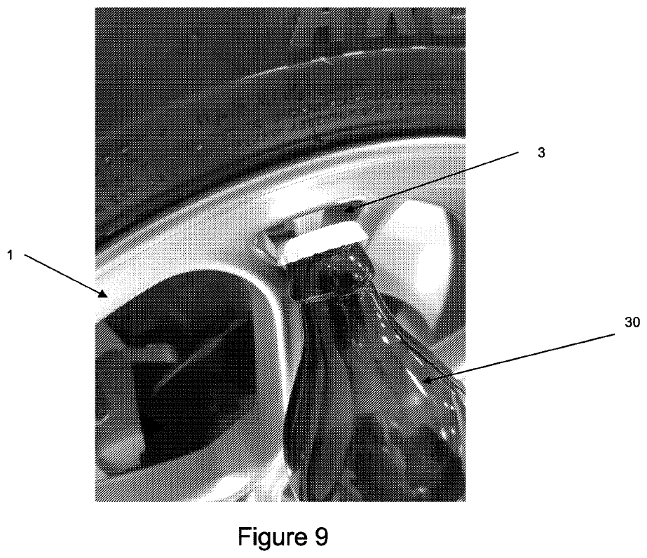

FIG. 9 illustrates the operation of uncapping a beverage bottle (such as a beer bottle) on the rim.

FIGS. 1 and 2 illustrate a general view of the principle of the invention and of the parts thereof mounted on a vehicle rim 1 (FIG. 1) or in an exploded view (FIG. 2) according to embodiments of the present invention.

In one embodiment, the present invention primarily forms an aerodynamic deflector 10 positioned at the most effective location for extracting air from the wheel arches, i.e. at the location where the rim 1 rotates most quickly, i.e. on the periphery of the rim 1, as illustrated in FIG. 1.

The deflector 10 is generally in the form of a vane allowing air to be extracted from the wheel arch toward the outside of the vehicle. The deflector has two symmetrical vanes 11, 12 (see FIG. 3) enabling it to be mounted (for example by clipping; see FIGS. 1 and 5) equally well on the right and left wheels 1 of the vehicle.

Once mounted (for example clipped), each deflector 10 will extract air from the wheel arches and deflect the air flow toward the outside of the vehicle, as illustrated and explained in FIGS. 7A and 7B. The faster the vehicle moves, the more the deflector 10 will extract air and thus reduce aerodynamic drag, which, in the end, makes it possible to increase the range of the electric vehicle. The shape of the rim 1 and of the deflector 10 that is shown in the figures is not exhaustive and many different styles of scoops can be produced with the invention that perform this function of extracting air from the wheel arches and deflecting the flow.

The attachment of the deflector 10 to the rim 1 is achieved by a suitable design or construction of the rim 1, for example with the means described below as a non-limiting embodiment: according to one embodiment illustrated in FIGS. 3, 4 and 5: a branch 2 of the rim 1 may advantageously comprise an opening 3 (FIG. 4), and the deflector 10 may comprise two flexible clips 13, 14 (see FIG. 3) inserted into the opening 3 (see FIG. 5). The openings 3 in the rims 1 are advantageously of generally triangular shape enabling the deflector 10 to be clipped onto at least two faces of the triangle; see FIG. 5. By virtue of the invention, multiple shapes of deflectors 10 and of rims 1 and rim branches 2 can be envisioned. The fixing may be by lateral clipping, by screwing, by adhesive bonding or any other fixing means. Preferably, but not exclusively, the fixing is reversible, i.e. the deflector 10 can be attached and detached easily with mechanical action. Unclipping can only be done by simultaneously pressing on both sides of the clip by passing the fingers behind the branch 2 of the rim. The shape of the branch 2 is designed so as to allow the fingers to be able to pass behind. Without this manual action on both sides simultaneously, the clip cannot be removed from the rim 1, even in the event of an impact.

Advantageously, the clipping imprint 3 (termed opening 3) of the rim on each branch 2 corresponds to the passage of the cap of the neck of a bottle 30 (for example a beer bottle 30). This arrangement 3 makes it possible to uncap it. This novel feature is illustrated in FIG. 9.

Moreover, the present invention makes it possible, on the one hand, to enhance the style of the structural casting (that is, a single mono-color rim) by removable colored parts, and, on the other hand, to add geometrical shapes that are difficult or even impossible to produce by casting.

By virtue of the invention, color touches and personalization are made possible without modifying the paint of the rim or its construction, which can be standardized.

Preferably, the rim 1 is adapted to receive deflectors, for example by virtue of the openings 3 into which the clips 13, 14 are inserted. In other embodiments, the rims 1 are standard and the deflectors 10 are adapted by suitable means for mounting them on said standard rim and/or the fixing means (for example adhesive bonding) allow said mounting of any deflectors on a standard rim.

The deflector 10 makes it possible to enhance the style of the rim (for example made of aluminum) by means of an additional part, which is advantageously made of polymer which gives a touch of color to the aluminum rim. The part thus added enhances the style of the rim by matching it favorably with that of the body of the vehicle, its color or with a graphic of the vehicle. It also makes it possible to sell accessories after the purchase of a vehicle and to propose colored variants very quickly, without the need to remove or change the rim.

Thus fixed, according to the embodiment illustrated in FIGS. 1, 5, 6 and 7B, the deflector 10 is firmly pressed by the clips 13, 14 against the rim 1 and locked in position in all the axes and cannot be detached from the rim without very particular external action. The deflector 10 can be unclipped instantaneously by pressing manually simultaneously on the two clips 13, 14 by passing over the inner face of the branch of the rim 1, as illustrated in FIG. 6.

At the moment of clipping, the geometry of the invention makes it possible to emit an audible click, guaranteeing the user that the deflector 10 is correctly in place and locked with a slight pressure of the clip 13, 14 on the rim 1. Without external manual intervention, the clipping of the deflector 10 and the deflector itself cannot be removed.

The deflector 10 can advantageously be produced by transparent polymer resin injection molding. It can be mounted transparently on the rim 1 (so as not to change its appearance) or it can also be painted on its internal face, which, once mounted on the rim 1, gives the deflector 10 an appearance of a deep gloss, as a transparent varnish of the thickness of the transparent part. Thus mounted against the rim 1, the paint and the edge of the aluminum rim are protected from scratches and impacts, from spraying cleaning products, from ultraviolet rays, by the thickness of polymer.

The deflector 10, when it is advantageously made of a transparent polymer, can be advantageously painted in the body color of the vehicle on the inner face 12. It can also be painted matching the nail varnish of the user on or in another color of choice (fashion, color according to the graphic chart of a company, colors of a sports club, etc.). In these cases, the operating mode according to embodiments is to unclip the deflector 10 from the rim 1, to transport the very light parts to the workshop where they will be decorated, to apply a varnish or a paint only on the internal face (or on the whole part), to allow it to dry and to re-clip the deflector on the rim 1. According to one embodiment, the fact of working on the internal face of the deflector 10 makes it possible to apply the varnish or paint very coarsely and quickly, because whatever the quality of the application of color to the face 12, only the face 11 of the deflector is visible through several millimeters of polymer.

The invention enables the user to color the internal face 12 very easily, benefiting from an ultra-glossy finish on the face 11 by virtue of the transparent thickness of the part which acts as a varnish of several mm.

The perceived glossy quality is independent of the quality of application to the internal face of the deflector 10. The invention makes it possible to use a paint spray can, a spray gun, a roller, or even a brush and does not require any particular professionalism since dripping or excess paint will not be visible on the 10 side. This thickness of polymer gives the rim a particularly qualitative and esthetic deep glossy appearance at a modest manufacturing cost.

This method opens the way to multiple customizations in production, in after-sales, or by the user, who can express their talent at any moment in the life of the vehicle.

According to embodiments, the invention further comprises a central nut cover 20 in a single piece which forms a cover which has a function of protecting the threads of the wheel fixing studs (see FIGS. 8A and 8B). It may also have an aesthetic function, for example in harmony with the deflectors 10 (see FIG. 1). It can advantageously be injection-molded transparently and painted or decorated on its rear face in the same way as the deflectors 10. It is clipped into a central hole in the rim 1 (as illustrated in FIG. 8A), and the shape of the clips 21 makes it possible to press it perfectly onto the rim. Removal is done, for example, by lifting one of the vanes 22 with a wire or a thin polymer blade slid between the rim 1 and the polymer part 20.

The invention makes it possible to mount and remove the deflectors 10 and the cover 20 at home and, by virtue of the lightness of these parts, to easily transport them to a workshop, for example for painting or exchanging them. It is also possible to transport them to a nail bar advantageously at the same time as having one's nails painted, without having to remove the rims. Of course, this is only a non-limiting example and this principle applies in other circumstances (exhibitions, tuning, advertising media, etc.). This ease of transport simplifies all the possible personalizations of the deflectors 10 and the cover 20.

In embodiments, the deflector 10 protrudes a few millimeters from the peripheral edge of the rim, but remains inside the overall tire, as illustrated in FIG. 3. This edge is the first to touch the sidewalk and thus protects the material of the rims 1 from friction and impacts against sidewalks or curbs, which damage the rims 1 during impacts occurring during maneuvers in an urban environment.

The deflector 10 forms a protective wall which will be the first in contact in the event of a sidewalk impact. Then, the deflector may possibly be changed and recycled, but it will have protected the rim 1 from costly repairs.

The elongate shape of the deflector 10 preferably forms a portion of about 70% of the circumference of the rim 1. After an impact, the deflector 10 will possibly be damaged or destroyed and will have to be exchanged, which represents a low cost compared with that of repairing a damaged rim 1. Being located a few millimeters outside the rim 1, the deflector 10 protects the edge of the rim from friction, thus preserving the paint from scratches and the aluminum of the rim from abrasion. The invention makes it possible to protect the rim 1, for example made of aluminum, from sidewalk impacts. Advantageously, the deflector 10 will be made of a polymer that is “unbreakable to impacts”, polycarbonate or copolyester. When the rim 1 is recycled, the deflectors 10 will be removed to avoid mixing of material and the material of the rim 1 can be recovered pure and recycled more easily.

The deflector 10 and the cover 20 may be made of a transparent material filled with reflective particles such as aluminum flakes, precious stones, or diamond-like glass, mother-of-pearl particles, marble, interference pigment, thermochromic pigment or any other filler included in the polymer allowing an esthetic effect on the rim 1.

The deflector 10 and the cover 20 may advantageously be injection-molded transparently and dyed with a pigment. The polymer may be filled with fluorescent or phosphorescent particles excited by the light of ambient lighting or headlights of other vehicles, allowing the rims 1 equipped with deflectors 10 (and with the cover 20) to be visible even in full darkness for the duration of the emission of photons. The invention allows additional safety: that of being visible in the evening or at night. The deflector 10 (and the cover 20) may be made through-colored and opaque with a large choice of color and be painted on the surface, with a paint incorporating the pigments and effect described above. Painting is carried out when the deflector 10 (or the cover 20) is removed from the rim 1, which simplifies this operation.

Once fixed to the rim, the deflector 10 is locked in a non-removable manner, centered in all the axes by the shape 3 and cannot detach from the receptacle 3 of the rim 1. The deflector 10 can be unclipped instantaneously by manually pressing simultaneously on both sides of the clips 13 and 14 by passing the fingers behind the branch 2.

Embodiments have been described with the purpose of providing an overall understanding of the principles of the structure, of the function, of the manufacture and of the use of the systems and methods described in the present application. Several of these embodiments are illustrated in the attached drawings described above. The systems and methods specifically described in the present application and illustrated in the attached drawings are non-limiting embodiments and the scope of the present invention is not defined solely by the claims. The features illustrated or described in connection with one embodiment may be combined with the features of other embodiments. Such modifications and variants are intended to be included within the scope of the present invention. A certain number of problems with the conventional methods and systems have been noted here and the methods and systems described here may address one or more of these problems. In addition, although this invention has been described in conjunction with a certain number of embodiments, the alternatives, modifications, equivalents and variants that fall within the spirit and scope of the present invention are also covered by the present application.

1. An add-on part fitted to a rim, for example a car rim, said part simultaneously configured for performing the functions of an aerodynamic deflector, of protecting the rim, for example from an impact against a sidewalk, and of a stylized personalization element.

2. The part as claimed in claim 1, said part forming a deflector.

3. The part as claimed in claim 1, comprising means for clipping on said rim in openings designed to allow said part to be clipped to the periphery of the rim.

4. The part as claimed in claim 1, comprising two symmetrical vanes enabling it to be mounted equally well on the right and left rims of the vehicle.

5. The part as claimed in claim 1, forming a central removable part mechanically and visually protecting the nuts of the rim.

6. The part as claimed in claim 1, wherein the shape of the clips and the opening are designed so as to be non-removable from the rim branch except when a deliberate pressure on the two clips and is applied simultaneously.

7. The part as claimed in claim 1, wherein the shape of the branch of the rim allows fingers to pass on each side to press simultaneously on the two clips and.

8. The part as claimed in claim 1, wherein the clipping of the part returns an audible feedback click during its assembly, making it possible to ensure the correct locking of the part on the rim.

9. The part as claimed in claim 1, said part protecting the rim from friction and sidewalk impacts.

10. The part as claimed in claim 1, said part being matched to the body tones of series or after-sales vehicles.

11. The part as claimed in claim 1, in which the user can vary the colors of these parts at any time at will on their vehicle.

12. The part as claimed in claim 1, said part made of transparent polymer making possible, by painting the internal face, a decorative personalization using the transparency of the part.

13. The part as claimed in claim 12, allowing the user themselves to color the internal face of these parts very easily, benefiting from an ultra-glossy finish on the face independently of the quality of application by using the transparent thickness of the part.

14. The transparent part as claimed in claim 1, said parts being made of retro-reflecting elements reflecting light or storing and re-emitting light either by phosphorescence or by fluorescence.

15. The part as claimed in claim 1, said part being made of transparent polymer and capable of receiving varnish matching the color of the nail varnish of the user of the vehicle on the face.

16. The part as claimed in claim 1, said part being able to be easily unclipped and transported to accompany the user to a nail bar or to a place suitable for its decoration.

17. The part as claimed in claim 1, said part being made of transparent polymer including fillers of precious stone, flakes, glass, or any other decorative particle.

18. The part as claimed in claim 1, said part being made of transparent polymer which can be coarsely painted on its inner face, the glossy finish being ensured by the polymer thickness.

19. The part as claimed in claim 1, said part being able to be made of a transparent or opaque through-colored material with a large choice of color and a large choice of fillers, glass, fluorescence to personalize the rims.

20. An arrangement of the clips of the part allowing a passage shape in the branch corresponding to a shape for uncapping a bottle.

21. A rim, for example for a vehicle, comprising at least one part as defined in claim 1.

22. A vehicle, such as, for example, a car, said vehicle comprising at least one rim as defined in claim 21.
